(19) United States
(12) Patent Application Publication
(10) Pub. No.: US 2024/0239709 A1
(43) Pub. Date: Jul. 18, 2024

(54) MIT NANOKOMPOSIT MODIFIZIERTER ASPHALTBINDER UND DESSEN HERSTELLUNG

(71) Applicant: TECHNISCHE UNIVERSITÄT BRAUNSCHWEIG, Braunschweig (DE)

(72) Inventors: Goshtasp CHERAGHIAN, Braunschweig (DE); Michael P. WISTUBA, Braunschweig (DE)

(21) Appl. No.: 18/492,040

(22) Filed: Oct. 23, 2023

(30) Foreign Application Priority Data
Oct. 21, 2022 (DE) 10 2022 127 872.7

(51) Int. Cl. C04B 14/10; C04B 14/04; C04B 26/26; C04B 103/60

(52) U.S. Cl. CPC C04B 14/10; C04B 14/04; C04B 26/26; C04B 2103/605

(57) ABSTRACT

The present invention relates to modified binders comprising nanocomposite based on clay and fumed silica, wherein said modified binder is in particular one which is suitable as an admixture for asphalt binders, in particular bitumen. In a further aspect, a method for producing said modified binder is provided, wherein the nanocomposite based on clay and fumed silica is produced by hydrothermal synthesis. In addition, compositions comprising the modified binders according to the invention, such as asphalt, are provided accordingly, as well as the use of these modified binders to improve the UV resistance, to increase the strength and/or to improve the crack resistance of asphalt.

The present invention relates to modified binders comprising nanocomposites based on clay and fumed silica, wherein said modified binder is in particular one which is suitable as an asphalt binder, in particular bitumen. In a further aspect, a method for producing this modified binder is provided, wherein the nanocomposites based on clay and fumed silica are produced by hydrothermal synthesis. In addition, compositions comprising the modified binders according to the invention, such as asphalt, are provided accordingly, as well as the use of these modified binders to improve the UV resistance, to increase the strength and/or to improve the crack resistance of asphalt.

### STATE OF THE ART

In the last decade, many studies have been conducted on the modification of bituminous binders with nanoparticles, see e.g. Shafabakhsh, G. A., et al, 2020, Construction and Building Materials, 237, 117640. It has been focused on new nanomaterials that improve certain properties of the binders, as described in Primohammad, S., et al, 2020, Construction and Building Materials, 239, 117850.

A key property of bituminous binders for asphalt is their ageing resistance. Ageing-resistant asphalts must exhibit good adhesion behaviour to the rock and remain elastic and crack-resistant to ensure a long service life. Factors that influence the ageing of bituminous binders and thus, for example, of asphalt with bituminous binders are oxidation, volatilisation (distillation) and thermodynamic structural changes (steric ageing).

While steric ageing results from a molecular rearrangement, oxidation and distillation are accompanied by a change in the molecules as a result of chemical transformation. In addition to temperature, ultraviolet solar radiation and the presence of (atmospheric) oxygen also play an important role in the ageing process. During ageing under the influence of UV radiation, bitumen partially absorbs the ultraviolet light emitted by solar radiation, which changes its molecular structure and chemical composition, Cheraghian, G., et al, 2018, In RILEM International Symposium of Bituminous Materials (879-885), Springer, Cham. UV radiation breaks the bonds of asphalt molecules and generates free radicals, which in turn accelerate the ageing process, e.g. in Xu, X., et al, 2016, 40(6), 947-953, Polymer(korea). Consequently, bituminous binders that are resistant to UV ageing are of great interest for use in asphalt road construction, for example. The same applies to other areas of application, such as in the construction industry, e.g. in the roofing and sealing industry or building construction in general. In particular, the sealing character and adhesive properties of bitumen are utilised here. If bitumen is permanently exposed to the weather, it becomes brittle and cracked due to the above-mentioned processes, such as oxidation but also exposure to UV light, and the modification of bitumen and bituminous binders has been the subject of studies for many years. However, studies on bitumen ageing usually do not take UV radiation into account and there is no standardised laboratory procedure for UV ageing. Few publications deal with the modification of binders using nanoparticles and their resulting effect on the radiation-dependent ageing properties. Nanoparticles of titanium dioxide, copper oxide, zinc oxide, silicon dioxide and montmorillonite as representatives of clay have been investigated to improve ageing resistance to UV radiation, e.g. Xie, X. et al, 2020, Advances in Materials Science and Engineering, 1-15.

These include zinc oxide (ZnO) and titanium dioxide (TiO₂) materials, which have also been used in other areas to achieve UV resistance. However, both can damage the structure of asphalt (see e.g. Xiong, M., et al., 2020, Journal of Dispersion Science and Technology, 41 (11), 1703-1710) and are relatively expensive. Organic, non-toxic clay particles can also effectively reduce the ageing of asphalt, as described by Liu, et al, 2019, Construction and Building Materials, 220, 637-650.

They also increase the binder's resistance to moisture.

Bitumen binders are extracted from crude oil. They are mainly composed of maltenes and asphaltenes. Maltenes are a mixture of saturated components, aromatics and resins, while asphaltenes surround these resins. Ageing increases the content of asphaltenes and resins, while at the same time the content of aromatics decreases. This is accompanied by embrittlement of the binder and increased cracking, i.e. a reduction in the crack resistance and strength of asphalt, for example.

Recently, Cheraghian et al, 2020 and 2021, see above, reported on studies on the ageing of silica nanoparticle modified bitumens. It was shown that the physical properties are influenced by silica nanoparticles as an additive to the bitumen. In particular, an improvement over UV ageing was shown with an increase in the nanoparticle components. The breaking strength and viscosity of the ageing bitumen was also improved.

Clay is a naturally occurring, predominantly inorganic material consisting mainly of clay minerals. These are mostly layered silicates in which other materials may be present, which influence plasticity, etc. Typical representatives of these clay minerals, namely phyllosilicates, are e.g. illite, montmorillonite or kaolinite. As already mentioned, clay can contain admixtures of other minerals, such as quartz, but also metal oxide and hydroxides, etc. Clay is used in many different ways and has been known for a long time. As mentioned, montmorillonite, for example, has been investigated to improve the ageing resistance of bitumen to UV radiation.

The delays achieved in the ageing of bituminous binders, e.g. in asphalt, require a further improvement. The aim of the present invention is to provide modified bituminous binders with nanocomposites which delay the ageing of e.g. asphalt caused by UV radiation and thus improve essential ageing-dependent properties of asphalt surface layers or of other materials essentially based on bitumen, in particular the strength and crack resistance and the resulting durability of the materials.

### DESCRIPTION OF THE PRESENT INVENTION

The object of the present invention is a modified binder comprising nanocomposite based on clay and fumed silica. It has surprisingly been shown that a combination of these two substances in the form of a nanocomposite as a modifier of binders, in particular bitumen, improves the stability thereof and improves the strength and crack resistance of such modified binders, such as modified bitumen-containing materials, such as asphalt, and thus increases the durability of these materials. These properties are achieved in particular when specific structures of the nanocomposite of fumed silica are formed.

The modified binder according to the invention is in particular a modified binder for use in asphalt.

When used in asphalt, for example, the binders according to the invention allow an improvement in the strength and crack resistance thereof in order to increase their durability. This is achieved in particular by the fact that the modification by the nanocomposites based on clay and fumed silica improves the UV ageing resistance.

In one aspect, the present application relates to a modified binder, wherein the nanocomposites of clay and fumed silica are produced by hydrothermal synthesis.

Hydrothermal synthesis allows compounds to be obtained from aqueous solutions in the hypercritical state range. Hydrothermal synthesis is based on the fact that water in the hypercritical temperature and pressure range has a significantly better solubilising capacity for many substances than under normal conditions. This property is particularly useful for growing crystals from substances that are difficult to dissolve. Hydrothermal synthesis is usually carried out under suitable conditions in an autoclave. In the present case, hydrothermal synthesis allows the formation of nanocomposites with corresponding agglomerates thereof.

Nanocomposites obtained in this way are shown below by way of example with reference to the figures.

The nanocomposites based on clay and fumed silica can be distributed in the binder in the form of aggregates. In particular, they can be dispersed evenly in the binder. It was found that the aggregation sizes of the nanocomposites can reach 400 to 800 nm, for example.

It is assumed that the new structures in the binder, which are due to the presence of nanocomposites, delay or prevent the ageing of the binder. This acts as a protective layer against solar radiation, reflecting ultraviolet light and thus protecting the binder from the penetration of UV light. It is assumed that the volatile chemical constituents contained in the binder are trapped by the nanocomposites according to the invention based on clay and fumed silica, which are also present as aggregates, so that they cannot escape from the binder. As shown in the figures, the nanoparticles of fumed silica form dense clusters on the clay nanolayers. As the number of nanoparticles per surface unit increases, the nanolayers absorb each other due to their polarity and chemical bonds and form dense aggregates. Tests show that the distribution in the binder is homogeneous and that the nanoparticles of fumed silicon dioxide evenly coat the clay layers.

The term “nanocomposite” is used here to mean that nanostructures of clay and pyrogenic silicon dioxide form these nanocomposites. These nanocomposites can reach aggregation sizes of 10 nm to 5 μm. In one embodiment, the aggregation sizes are in the range from 20 nm to less than 1 μm. As explained, the nanocomposites are produced from nanoparticulate clay and pyrogenic silicon dioxide by hydrothermal synthesis. Suitable processes are known to the skilled person, examples of which are explained further below.

The term “pyrogenic silicium dioxide” or “fumed silica” or “pyrogenic silica” or “fumed silicium dioxide” is used herein to mean that fumed silica is a form of colloidal silicium dioxide produced by flame hydrolysis process. This involves producing a microscopically small suspension of amorphous nanometrically based on silicium dioxide, which forms interconnected there-dimensional particles. Due to the three-dimensional structure and the small size of the primary particles fumed silica has an exceptionally large surface area.

In one embodiment, the modified binder is one wherein the particle size of the nanoparticulate clay is in a range of 10 to 50 nm, such as 20 to 35 nm, and of fumed silica is in a range of 20 to 100 nm, such as 25 to 70 nm.

The particle size is determined according to conventional methods, e.g. by means of a method using SEM imaging.

In one aspect, the weight ratio of clay to fumed silica is 0.3 to 10 to 2 to 1, like 0.5 to 10 to 1 to 1. For example, the weight ratio of clay to fumed silica is in a range of 2 to 10, to 1 to 1. In one embodiment, the weight ratio of clay to fumed silica is 4 to 10 or 1 to 1.

Due to these corresponding weight ratios, the above-described distributions of silicon dioxide on the nanostructures of the clay layers are possible, so that the silicon dioxide evenly coats the clay layers.

In the present case, “clay” is understood to mean conventional clay materials, in particular phyllosilicates. Suitable phyllosilicates are in particular illite, montmorillite or kaolinite. Pyrogenic silicon dioxide can be produced using conventional processes. TEOS, for example, can be used here as starting materials.

In a further embodiment of the present invention, the modified binder is a modified bitumen. Bitumen is used as a binder in many areas and the modification thereof according to the invention makes it possible to improve its resistance and durability, in particular its strength and resistance to cracking.

In a further aspect, the modified binder according to the invention is one wherein the nanocomposite of clay and fumed silica has a specific surface area range of 10 to 1,000 m²/g such as 20 to 500 m²/g. The modified binder, in particular in the form of modified bitumen, is suitable as a corresponding binder in the usual uses thereof, here for example in road construction, building construction or in the roofing sector.

In a further aspect, the present invention relates to a method for producing modified binder, in particular binder modified according to the invention. In a first step, the method comprises the hydrothermal synthesis of clay and pyrogenic silicon for the production of nanoscale composites. These nanoscale composites produced in this way are then mixed into the binder in a further step in order to obtain a modified binder according to the invention.

The mixing of the nanocomposites produced, for example in the form of corresponding aggregates, into the binder can be carried out according to conventional processes.

In one aspect, the process according to the invention is one in which the hydrothermal synthesis is as follows:
Dispersion of the clay in an aqueous medium;
introducing organic surfactants in an aqueous medium into the clay suspension;
adding a silicate, pyrogenic silicium dioxide, to the clay suspension containing organic surfactants, and
heating the mixture to a temperature in the range from 150° C. to 210° C., such as 165° C. to 195° C., in particular 180° C., for a period of 8 to 24 hours, such as 12 to 20 hours, in particular 16 hours, the heating preferably taking place in an autoclave.

The term “organic surfactants” is understood to mean conventional organic surfactants as known to the person skilled in the art. These include: cetyltrimethylammonium bromide and polyethylene glycol.

Cetyltrimethylammonium bromide is a quaternary ammonium compound with a long-chain alkyl group with 16 carbon atoms.

In a first step, the clay is dispersed in an aqueous medium. If necessary, the pH value of the medium is increased by adding an appropriate base and further dispersed with additives if necessary. Organic surfactants are then added to further improve solubility. These surfactants, in particular organic surfactants, are added to the corresponding clay suspension in the form of an aqueous solution. Subsequently or, alternatively, simultaneously, a silicate is added to the mixture, i.e. an aqueous organic surfactant solution and a silicate are added to the clay suspension successively, simultaneously or first alone and then simultaneously. This mixture is then heated, for example to a temperature range of 150° C. to 210° C., such as 165° C. to 195° C., in particular 180° C., for a sufficient period of time to produce the nanocomposites of clay and fumed silica according to the invention. This heating period is usually one of 8 to 24 hours, such as 12 to 20 hours, e.g. 16 hours. The heating is preferably carried out in an autoclave in order to achieve the necessary conditions for hydrothermal synthesis.

Variations of the process sequence described above are known to the skilled person in order to obtain the composition of clay and fumed silica in the form of nanocomposites according to the invention. If necessary, this composition is heated to remove the organic surfactants.

The resulting powder can then be incorporated into the binder. This is usually done by adding the binder and the nanocomposites, for example by heating the nanoscale particles and the binder at 130° C. to 180° C., such as 150° C., for 5 to 30 minutes, such as 10 to 15 minutes, and then cooling. In one embodiment, the modified binder is a modified bitumen.

In a further aspect, the present invention is directed to correspondingly obtainable modified binders obtainable by the method according to the invention.

Furthermore, the present application is directed to a material comprising the modified binder according to the invention. Such materials include in particular asphalt, but also other bitumen binders, e.g. in the construction sector.

The modified binders obtainable by the method according to the invention or the modified binders according to the invention are particularly suitable for improving the UV resistance and/or for increasing the strength and/or for improving the crack resistance of asphalt.

The present invention is described in more detail with the aid of examples, without being limited to this.

### EXAMPLES

The nanocomposites are produced using hydrothermal synthesis. The size distribution of the materials as discussed further and shown below in the figures, the structure of X-ray diffraction using dynamic light scattering (DLS) and X-ray powder diffraction (XRPD) were performed.

### Preparation of the Nanocomposites:

Four grams of montmorillonite and 0.48 g of sodium hydroxide were dissolved in 200 ml of deionised water at a temperature of 25° C. for three hours and then dispersed using an ultrasonic mixer.

For this purpose, 2 ml of PEG and 4 g of cetyltrimethylammonium bromide (CTAB) were dispersed in 40 ml of distilled water. The resulting surfactant solution of PEG/CTAB was stirred into the mixture for three hours. At the same time, 10 ml of tetraethyl orthosilicate (TEOS) was injected into the suspension.

Subsequently or at the same time, fumed silica is added in a suitable ratio, like in the range of from 2 to 5 to 1 to 1, like of from 4 to 10 with regard to the montmorillonite. The resulting mixture was heated in a stainless steel autoclave to a temperature of 180° C. for 16 hours and then cooled to 25° C. The resulting powder was heated again, e.g. to remove the organic surfactants.

A Petrotest machine according to ASTM D36 was used to determine the ring-and-ball softening point of the binders. The ductility test was carried out using a ductilometer device with a digital diameter of 1,500 mm in accordance with ASTM D113. An automatic penetrometer was used to determine needle penetration in accordance with ASTM D5.

Table 1 summarizes the physical properties of the binder obtained according to the method described above:

| physical properties | value | standard |
|---|---|---|
| Ductility (@25° C., cm) | 100 | ASTM D113 |
| Softening point (° C.) | 48.6 | ASTM D36 |
| Penetration (@25° C., 0.1 mm) | 63 | ASTM D5 |
| Density (kg/m³) | 1.03 | ASTM D70 |

For further analysis, the samples were subjected to FTIR spectrometry with a transmission mode in the spectral range from 400 to 4,000 cm-1. FTIR records the reflection of the various infrared spectra of chemical bonds. Carbonyl and sulphoxide bonds are formed by UV radiation, which forms carbon-carbon or carbon-hydrogen bonds.

Carbonyl functions (C═O) and sulphoxide functions (S═O) were observed with spectra of 1,700 cm-1 and 1,030 cm-1 respectively. Both values can be derived from the oxidation range of the asphalt.

### DESCRIPTION OF THE FIGURES

FIG. 1 Nanocomposite of clay and fumed silica prepared by hydrothermal synthesis.

FIG. 2 Complex shear modulus (G*) and phase angle (8) of the nanocomposite-modified binder after (a) 6 days of UV ageing, and after (b) 12 days of UV ageing.

FIG. 3 Aging indices based on carbonyl and sulfoxide groups at different aging conditions.

FIG. 4 DLS distribution, XRD pattern and FTIR of nanoparticles of a) clay, and b) fumed silica.

FIG. 5 Schematic representation of the multi-step synthesis of nanoparticles from clay and fumed silica.

FIG. 6 Schematic representation of the effect of the nanocomposite of clay and fumed silica on the colloidal structure of the binder.

### DETAILED DESCRIPTION OF THE FIGURES

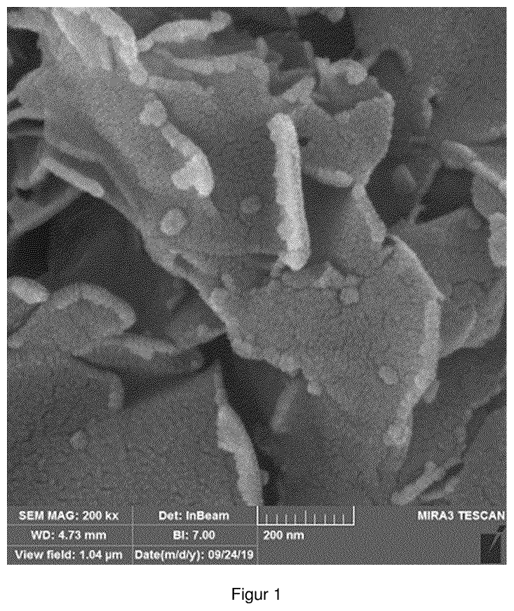

FIG. 1 shows results from field emission scanning electron microscopy and illustrates the surface morphology of the nanocomposite dispersed in the modified binder sample. A unique complex structure of nanosheets is formed. When the nanocomposite is mixed with the binder, it partially covers the surface of the binder, and when a certain threshold is exceeded, the nanocomposite starts to aggregate and form a structure of multiple layers (FIG. 1). This particle aggregation changes the homogeneity of the mixture and can also change its rheological properties. Around the aggregation of the nanocomposite, a uniform dispersion zone can be seen on the surface of the binder, which covers the binder with a thin film of nanocomposite (individual layers).

The aggregates of the nanocomposite were always evenly distributed in the binder sample, which indicates that they dispersed evenly during the mixing process. The aggregation sizes of the nanocomposite ranged from 400 to 800 nm. The new structure in the binder, which is due to the presence of the nanocomposite, delays or prevents the ageing of the binder: it acts like a protective layer against solar radiation, reflecting ultraviolet light and thus protecting the binder from UV light penetration. It literally traps volatile chemical components contained in the binder, thus preventing their evaporation. FIG. 1 shows that nanoparticles of fumed silica form dense clusters on the clay nanolayers. As the nanocomposite per surface unit increases, the nanosheets adsorb each other due to their polarity and chemical bonds and form dense aggregates. The elemental distribution was visualised by energy dispersive X-ray spectroscopy (EDS) (with the addition of 0.1 wt % zinc oxide) (not shown). The mapping shows that the distribution in the binder is homogeneous and the nanoparticles of silicon dioxide evenly coat the clay layers. Furthermore, the zinc dispersion indicates that the production of hydrothermal nanocomposites works: The mappings of iron oxide and magnesium oxide are approximately the same, indicating an even distribution of the clay particles.

Rheological tests showed that the addition of 0.2% by weight of the nanocomposite significantly increased the stiffness and thus the complex shear modulus of the binder samples modified with the nanocomposite compared to unmodified reference samples.

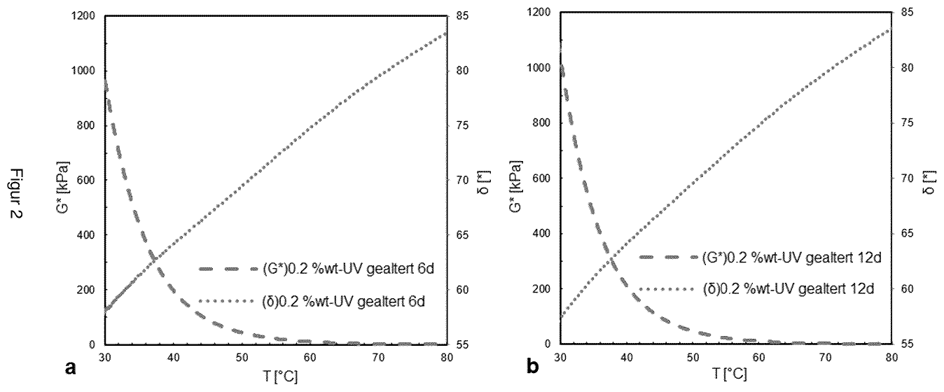

In FIG. 2, the results for UV ageing show how the radiation-induced ageing increases the complex shear modulus of the unmodified reference binder.

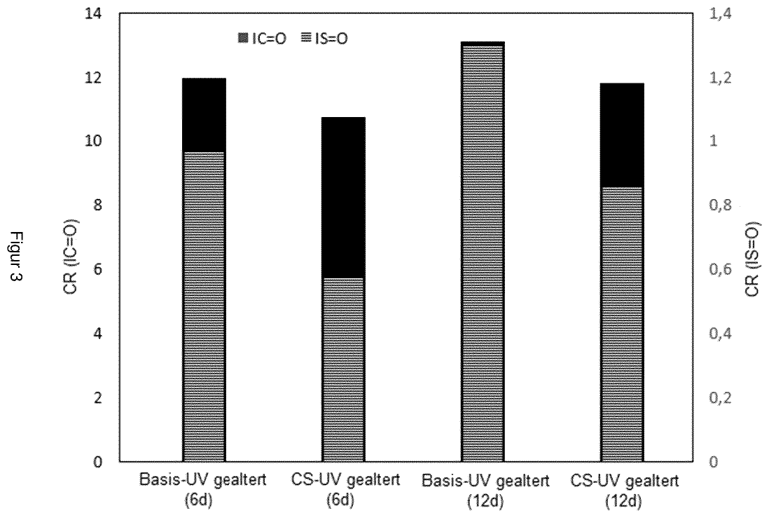

FIG. 3 shows the changes in the carbonyl and sulfoxide indices when carbonyl is increased to 3.41 and 1.08, respectively, and when sulfoxide is increased to 0.426 and 0.285, respectively, after 6 and 12 days of UV irradiation, without and with nanoparticles. These data indicate that the UV-shielding effect of the nanocomposite is extremely efficient. It can be assumed that the nanocomposite has the ability to reflect UV light efficiently on the one hand and absorb it efficiently on the other. The results show that even a content of 0.2% by weight significantly increases the UV ageing resistance.

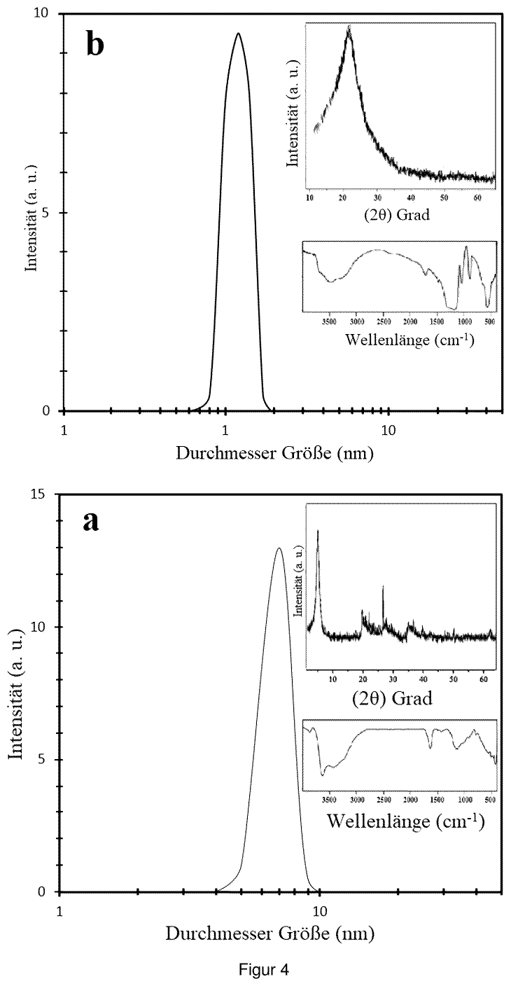

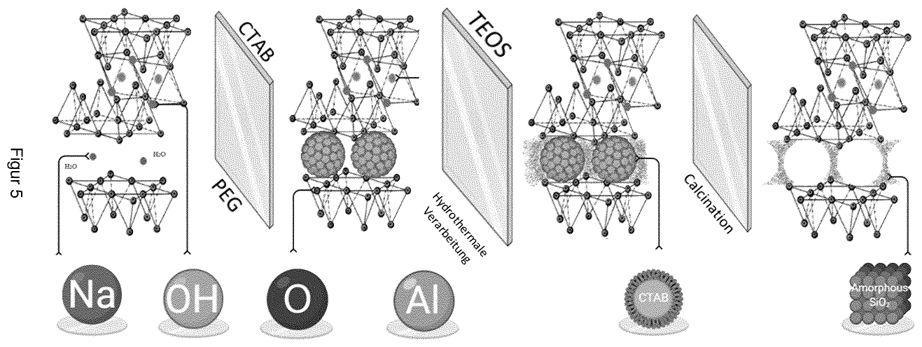

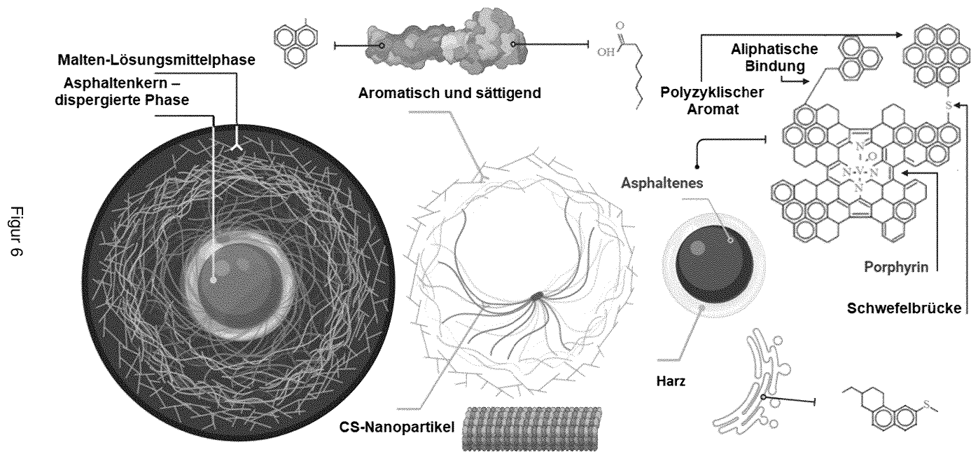

The size distribution of the materials and the X-ray diffraction pattern with dynamic light scattering and X-ray powder diffraction are shown in FIG. 4. FIG. 5 shows the production of the nanocomposite by hydrothermal synthesis. The interactions between the molecules of the nanocomposite and the binder are determined by the bonding of hydroxyl groups on the bitumen surface to the silicon nanoparticles and are due to the high surface energy of the silicon nanoparticles. In addition, the surface-to-volume ratio of the clay nanosheets is an important factor. The silicon nanoparticles are connected to the bitumen molecules by chemical bonds, and the bitumen components interact with the nanoparticles by physical reactions (van der Waals forces). Based on the colloidal structure of the bitumen (FIG. 6), the asphaltenes form the dispersed phase in the paint phase. The average diameter of asphaltenes is 0.5-40 nm and can therefore lead to considerable changes in the material properties. Nanocomposites (the average particle size of clay nanosheets and silicon nanoparticles is about 12 and 33 nm respectively) can react chemically and disperse between these colloidal dimensions (shown schematically in FIG. 6). In addition, the clay nanolayers change the surface properties of bitumen. The polarity of the clay nanolayers (in combination with other elements) reduces the polarity and adsorption of asphaltenes. This is a complex mechanism in which sodium elements (found in clay) adsorbed by asphaltene carbons lead to saturation of the molecules. They are distributed in the colloidal structure of the bitumen in the form of nanolayers with a size of 1-100 nm, which hinders the penetration of oxygen into the binder. The nanocomposite also increases the stability of the modified binder and prevents the destruction of the chemical structure of the bitumen components.

1. Modified binder containing clay and fumed silica based nanocomposites.

2. Modified binder according to claim 1, wherein the modified binder is a modified asphalt binder.

3. Modified binder according to claim 1, wherein the clay and fumed silica based nanocomposites are produced by hydrothermal synthesis.

4. Modified binder according to claim 1 wherein the clay and fumed silica based nanocomposites include clay having a particle size in a range of from 10 to 50 nm, and wherein the clay and fumed silica based nanocomposites include fumed silica having a particle size in a range of from 20 to 100 nm.

5. Modified binder according to claim 1, wherein the binder is a bitumen.

6. Modified binder according to claim 1, wherein an amount of proportion of the clay and fumed silica based nanocomposites in the modified binder is 0.05 to 2% by weight.

7. Modified binder according to claim 1 wherein a ratio of clay to fumed silica by weight in the clay and fumed silica based nanocomposites is 0.5 to 10.

8. Modified binder according to claim 1 wherein the clay and fumed silica based nanocomposites have a specific surface area in a range from 10 to 1000 m²/g.

9. Process for preparing modified binder according to claim 1, comprising:
a) a hydrothermal synthesis of clay and fumed silicon to produce nanoscale particles, and
b) mixing the nanoscale particles into a binder for modification thereof.

10. The process according to claim 9, wherein the hydrothermal synthesis according to step a) comprises:
dispersing the clay in an aqueous medium to form a clay suspension;
introducing organic surfactants in an aqueous medium into the clay suspension to form a clay suspension containing organic surfactants;
adding a silicate to the clay suspension containing organic surfactants to form a mixture, and
heating the mixture to a temperature in the range from 150° C. to 210° C. for a period of 8 to 24 hours.

11. The process according to claim 9, wherein the nanoscale particles and the binder are heated at 130° C. to 180° C. for 5 to 30 minutes, and are then cooled.

12. The process according to claim 9, wherein the binder is bitumen.

13. Modified binder obtained by a process according to claim 9.

14. Asphalt containing a modified binder according to claim 1.

15. A method to improve the UV resistance, and/or to increase strength and/or improve/crack resistance of asphalt comprising incorporating into the asphalt the modified binder of claim 1.

16. The process according to claim 10 wherein heating takes place in an autoclave.

17. The process according to claim 10 wherein the nanoscale particles and the binder are heated at 130° C. to 180° C. for 5 to 30 minutes, and are then cooled.

18. Modified binder according to claim 8 wherein the specific surface area is in the range of 20 to 500 m²/g
